(19) United States
(12) Patent Application Publication
(10) Pub. No.: US 2018/0302486 A1
(43) Pub. Date: Oct. 18, 2018

(54) PROXY APPARATUS AND METHOD FOR DATA COLLECTION

(71) Applicant: Futurewei Technologies, Inc., Plano, TX (US)

(72) Inventors: Lin Ma, San Jose, CA (US); Peter M. Pham, San Jose, CA (US); Wei Chung Chuo, Redwood City, CA (US); Feng Ye, San Jose, CA (US); Lawrence Davison, San Jose, CA (US); Chen Tian, Union City, CA (US)

(21) Appl. No.: 15/486,151

(22) Filed: Apr. 12, 2017

(51) Int. Cl. H04L 29/08; H04L 12/26

(52) U.S. Cl. CPC H04L 67/28; H04L 43/06; H04L 43/50

(57) ABSTRACT

A proxy processing device and associated method are provided to receive control signals from a manager that are based on user input received by the manager. Further, the control signals are sent to an agent for controlling one or more aspects of a collection of data from at least one node and a communication of the data to a destination via at least one channel. The collection of the data and the communication of the data is performed by the agent utilizing a plurality of software components that each customizes the one or more aspects of the collection of the data and the communication of the data.

### FIELD

The present disclosure relates to data collection systems, and more particularly to collecting data using an agent-based architecture.

### BACKGROUND

Traditionally, data collection tools (e.g. system/application log data collectors, performance monitoring systems, network monitoring systems, etc.) are designed for a single purpose with moderate scalability. As a result, when data is to be collected from different sources (and possibly for different purposes), it often requires different sets of tools. Together, these tools not only consume considerable system resources, but also create a deployment and management burden on system administrators.

### SUMMARY

A proxy processing device is provided including a non-transitory memory storing instructions, and one or more processors in communication with the non-transitory memory. The one or more processors execute the instructions to receive control signals from a manager that are based on user input received by the manager. Further, the control signals are sent to an agent for controlling one or more aspects of a collection of data from at least one node and a communication of the data to a destination via at least one channel. The collection of the data and the communication of the data are performed by the agent utilizing a plurality of software components that each customizes the one or more aspects of the collection of the data and the communication of the data.

Also provided is a computer-implemented method. Control signals are received from a manager, where the control signals are based on user input received by the manager. Further, the control signals are sent to an agent for controlling one or more aspects of a collection of data from at least one node and a communication of the data to a destination via at least one channel. The collection of the data and the communication of the data are performed by the agent utilizing a plurality of software components that each customizes the one or more aspects of the collection of the data and the communication of the data.

A computer program product is further provided comprising computer executable instructions stored on a non-transitory computer readable medium that when executed by a processor instruct the processor to receive control signals from a manager that are based on user input received by the manager. Further, the control signals are sent to an agent for controlling one or more aspects of a collection of data from at least one node and a communication of the data to a destination via at least one channel. The collection of the data and the communication of the data are performed by the agent utilizing a plurality of software components that each customizes the one or more aspects of the collection of the data and the communication of the data.

Optionally, in any of the preceding embodiments, the one or more aspects may include a selection of the destination of the data among a plurality of destinations.

Optionally, in any of the preceding embodiments, the one or more aspects may include a selection of the at least one channel among a plurality of channels.

Optionally, in any of the preceding embodiments, the control signals may further be for controlling one or more aspects of a processing of the data collected from the at least one node before the communication of the data to the destination. As an option, the processing may include sampling, encryption, and/or filtering of the data.

Optionally, in any of the preceding embodiments, a communication of the proxy processing device with the agent may be more frequent than a communication of the proxy processing device with the manager.

Optionally, in any of the preceding embodiments, the agent sends an initialization signal to the manager, and the manager, in response to the initialization signal, instructs the agent to communicate with the proxy processing device. As an option, the manager instructs the agent to communicate with the proxy processing device, based on an availability and/or a location of the proxy processing device.

Optionally, in any of the preceding embodiments, status information may be received from the agent, and sent to the manager, where the control signals are based, at least in part, on the status information.

Optionally, in any of the preceding embodiments, the manager conducts load balancing in connection with the proxy processing device based on a number of the agents in communication with the proxy processing device.

Optionally, in any of the preceding embodiments, the software components may be capable of including different types of software components.

Optionally, in any of the preceding embodiments, the software components may include plugins. Such plugins may include a first plugin for the collection of the data and a second plugin for the communication of the data to the destination via the at least one channel. Further, the plugins may include a third plugin for the processing of the data collected from the at least one node before the communication of the data to the destination.

One or more of the foregoing features of the aforementioned embodiments may enable the control of multiple data collection software components (e.g. plugins, etc.) via a single agent, thereby providing for a more streamlined approach to plugin administration and control via a manager. In still other embodiments, one or more proxies are positioned between the foregoing manager and a plurality of the aforementioned agents in order to permit (in some embodiments) more persistent communication between such agents and the proxies, without necessarily requiring such additionally-persistent communication with the manager, to accommodate the fact that the manager may, in some embodiments, be more remotely deployed. This may, in turn, result in a more efficiently/effectively managed system that is more readily scalable which would otherwise be foregone in systems that lack such features. It should be noted that the aforementioned potential advantages are set forth for illustrative purposes only and should not be construed as limiting in any manner.

### BRIEF DESCRIPTION OF THE DRAWINGS

FIG. 1 illustrates a system for data collection, in accordance with an embodiment.

FIG. 2 illustrates a system for data collection, in accordance with another embodiment.

FIG. 3 illustrates a method for data collection, in accordance with another embodiment.

FIG. 4 illustrates an agent software framework for collecting data, in accordance with an embodiment.

FIG. 5 illustrates a plugin stack for collecting data, in accordance with another embodiment.

FIG. 6 illustrates a proxy server, in accordance with an embodiment.

FIG. 7 illustrates a manager, in accordance with an embodiment.

FIG. 8 illustrates a mapping server, in accordance with an embodiment.

FIG. 9 illustrates a graphical user interface (GUI)-equipped central control system, in accordance with an embodiment.

FIG. 10 illustrates a sample GUI for administering a system, in accordance with an embodiment.

FIG. 11 illustrates a data collection system, in accordance with an embodiment.

FIG. 12 is a diagram of a network architecture, in accordance with an embodiment.

FIG. 13 is a diagram of an exemplary processing device, in accordance with an embodiment.

### DETAILED DESCRIPTION

Various possible embodiments are described herein that enable the control of multiple data collection software components (e.g. plugins, etc.) via a single agent, thereby providing for a more streamlined approach to plugin administration and control via a manager. In still other embodiments, one or more proxies are positioned between the foregoing manager and a plurality of the aforementioned agents in order to permit (in some embodiments) more persistent communication between such agents and the proxies, without necessarily requiring such additionally persistent communication with the manager, to accommodate the fact that the manager may, in some embodiments, be more remotely deployed.

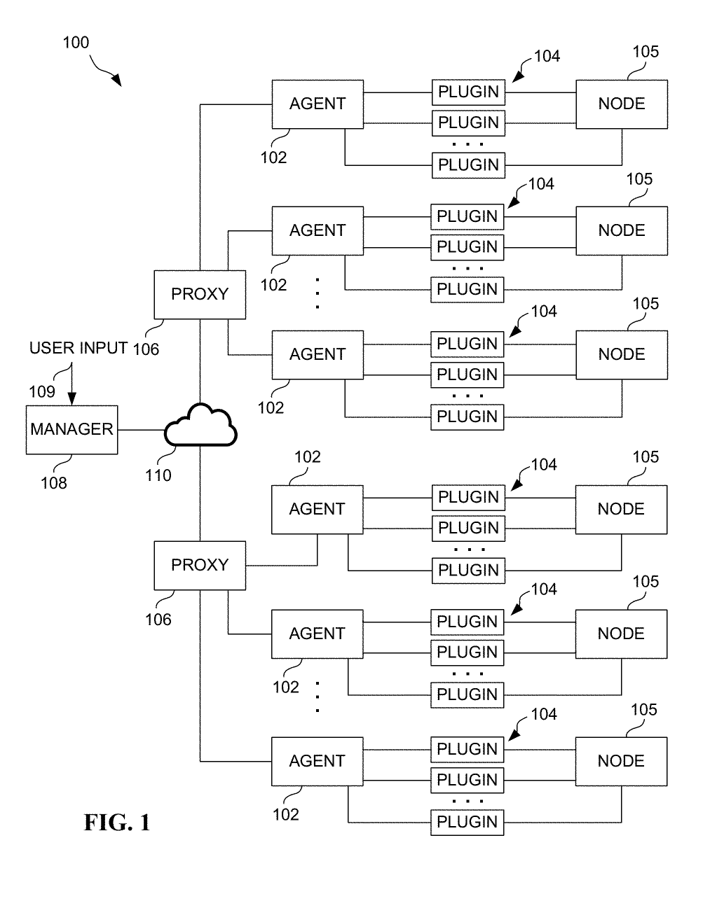

FIG. 1 illustrates a system 100 for data collection, in accordance with an embodiment. As shown, the system 100 includes a plurality of agent processes 102 (hereinafter “agents 102”) that are each in communication with multiple software components in the form of plugins 104 which, in turn, are in communication with a plurality of nodes 105 (e.g. servers, user devices, embedded devices, etc.) for collecting data therefrom. The system 100 further includes a manager process 108 (hereinafter “manager 108”) that is in communication with the agents 102 via at least one network 110 (e.g. Internet, wide area network (WAN), network of routers/switches, etc.) and one or more proxies 106.

While the foregoing components are shown to communicate directly with each other (such as by sending messages using inter-process communication, for example), it should be noted that the foregoing communication may be indirect via additional (unillustrated) components. Further, while shown to be discrete, the agents 102, plugins 104, and the nodes 105 (and any other of the illustrated components) may be integrated, as desired. Still yet, it should be noted that each of the foregoing components may include any software and/or hardware (examples of which will be described later) that is capable of carrying out one or more of the functionalities described below. More information will now be set forth regarding each of the foregoing components, and an operation and interoperability thereof.

In use, the agents 102 are each configured for collecting data from the respective node(s) 105, utilizing the plugins 104, and communicating such data to a destination via at least one channel (that will be elaborated upon during the description of subsequent embodiments). In the context of the present description, such data may refer to any information that includes, describes, and/or is derived from an operation of the respective node(s) 105. In various embodiments, such data may involve a processor load, a memory or disk usage, a port status, a network statistic, log monitoring, and/or any other aspect of the operation of the respective node(s) 105.

Also in the present description, the aforementioned agents 102 may each include to any software and/or hardware that is capable of using a plurality of software components (such as the plugins 104) to collect/communicate the data. Further, in the present description, the software components may include any software and/or hardware configured to customize one or more aspects of the collection of the data and the communication of such data via the agent(s) 102. For example, in various embodiments, such aspect(s) may involve a destination (to which the data is communicated) among a plurality of destinations, at least one channel (via which the data is communicated) among a plurality of channels, and/or a processing (e.g. sampling, filtering, encryption, etc.) of the data collected from the node(s) 105 before the communication of the data to the destination. More information regarding examples of such destinations, channels, etc. will be elaborated upon during the description of subsequent embodiments

In one possible embodiment, the software components (e.g. plugins 104, etc.) may be capable of including different types. For example, the software components (e.g. plugins 104, etc.) may, in one optional embodiment, be developed by different entities (e.g. vendors, developers, etc.) and/or for different purposes (e.g. different data collection purposes). In other embodiments, however, the software components (e.g. plugins 104, etc.) may be developed by a single entity and/or for a same/similar purpose, but yet still be capable of customization in terms of the collection and communication of data. In any case, the software components (e.g. plugins 104, etc.) may be configured to collect and/or communicate the data differently (with respect to each other), etc.

To accomplish this in accordance with one possible embodiment, the software components may specifically take the form of plugins 104 which, in the context of the present description, may include executable software components that are configured to communicate with a corresponding agent(s) 102 via an application program interface (API) and further customize a functionality of the corresponding agent(s) 102. In some possible embodiments, such executable software components may include, but are not limited to as binaries, libraries, scripts (e.g. shell script, python script, JavaScript, etc.), and/or jar files. In additional optional embodiments, the plugins 104 may be registered with the corresponding agent(s) 102 via an API. As an option, such registration may be dynamic by virtue of the addition, removal, and/or updating of the plugins 104. By this design, upon execution of the corresponding agent(s) 102, such agent(s) 102 may locate any and all registered plugins 104 and execute the same so that additional functionality resulting from such execution may customize (e.g. enhance, extend, etc.) an operation of the agent(s) 102, as will be elaborated upon later.

For clarity, the remaining description of the present embodiment shown in FIG. 1 will assume that the aforementioned software components specifically include plugins 104 with the understanding that other software components (e.g. extensions, add-ons, etc.) may be employed in lieu of/addition to the plugins 104, in other embodiments.

During operation, the aforementioned aspect(s) by which the plugins 104 operate differently may also be configured (e.g. selected, controlled, etc.) by a user via the manager 108 so that the different plugins 104 may be controlled in a more streamline manner. In various embodiments, such configuration may occur during initialization (e.g. system set-up) and/or during run-time for on-the-fly configuration or re-configuration. To accomplish this, the manager 108 may include any hardware and/or software configured for receiving user input 109 for controlling the aforementioned aspect(s) of the collection of the data from the node(s) 105 and the communication of the data to the destination, and further generating control signals (e.g., in the form of transmitted messages or other inter-process communication) based on such user input 109. In the present description, such user input 109 may include any input via any local or remote interface that is received at any time (e.g. beforehand such as at initialization, in real-time, post-operation, etc.). Further, in various embodiments, the control signals may include commands, instructions, or any other signaling including, but not limited to a start command for starting data collection, a stop command for stopping data collection, a command for initializing software and/or configuration updates, etc.

In order to support communications between the manager 108, and the agents 102 and the plugins 104 (via the respective agent(s) 102), the proxy servers 106 (hereinafter “proxies 106”) may include any hardware and/or software that is configured for deployment between the respective agents 102 and the manager 108 for communication therewith. In various embodiments, such communication may be achieved via a coupling that may take any form including, but not limited to a direct coupling (e.g. with no components therebetween), indirect coupling (e.g. with one or more components therebetween), local network, and/or wide area network. With that said, the embodiment shown in FIG. 1 involves a network 110-based connection between the manager 108 and the proxies 106, and a more direct/local connection between the proxies 106 and the respective agents 102 (and associated plugins 104).

In order to support the control of the agents 102 and/or plugins 104 by the manager 108, the proxies 106 may be configured for receiving the control signals generated by the manager 108, and controlling the aforementioned aspect(s) of the collection of the data from the node(s) 105 and the communication of the data to the destination, based on the control signals. In one embodiment, this may be accomplished by simply relaying such control signals, and/or time-shifting or aggregating such control signals before communicating them to the agents 102 (and the plugins 104 via the respective agent(s) 102). In other embodiments, additional processing of the control signals may be employed including, but not limited to re-formatting, transforming, etc. the signals before relaying the same. As will be elaborated upon later, additional signaling may occur between the agents 102, and the manager 108 (via the proxies 106) including providing status updates on the status of the agents 102 (and associated plugins 104), to the manager 108.

In any case, as one possible option, the communication between the agents 102 and the proxies 106 may be more frequent (e.g. persistent) than the communication between the manager 108 and the proxies 106. By this design, the manager 108 may be more remotely (and possibly centrally) located via one or more unreliable/slower networks, while still permitting more speedy collection of data from the agents 102 and/or plugins 104, by the proxies 106.

Thus, in some optional embodiments, the proxies 106 offload the burden of communicating with the agents 102 from the manager 108, and optimize network traffic between the proxies 106 and the manager 108 for scalability. In such possible embodiments that require large scale agent deployment, the proxies 106 may be horizontally scalable and, therefore, may be deployed as a cluster of duplicate servers for agent load distribution and high availability. Such clusters of proxies 106 may further be deployed anywhere without geographical limitation (e.g. at data centers around the globe, etc.) to serve the needs of agents 102 in proximity. In this sense, the proxies 106 may serve as an infrastructure for extending the reach of the system 100 to where to-be-collected data resides.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the other features described.

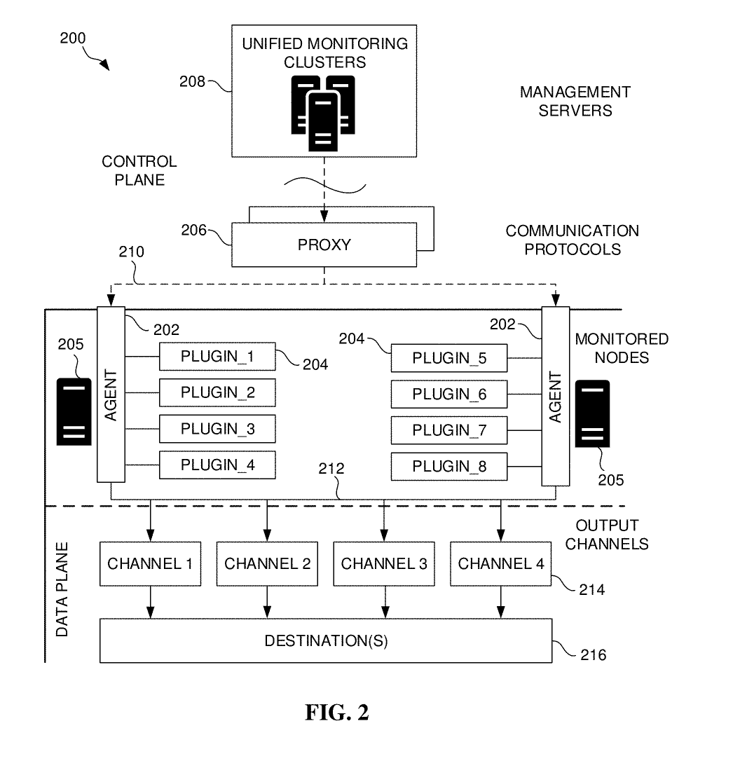

FIG. 2 illustrates a system 200 for data collection, in accordance with another embodiment. As an option, the system 200 may be implemented in the context of any one or more of the embodiments set forth in any previous and/or subsequent figure(s) and/or the description thereof. For example, in one possible embodiment, any of the features of the system 200 may be implemented in the context of the system 100 of FIG. 1 (or visa-versa). However, it is to be appreciated that the system 200 may be implemented in other suitable environments.

Similar to the system 100 of FIG. 1, the system 200 includes a plurality of agents 202 each equipped with a plurality of software components in the form of plugins 204 for collecting data from respective nodes 205. Further, such plugins 204 may be different in the manner in which the data is collected (e.g. the type of data collected, timing/speed of such collection, etc.), the manner in which it is processed (e.g. sampled, filtered, encrypted, etc.), and/or the manner in which the data is shared with one or more destinations 216 via one or more channels 214 (e.g. the specific destination(s) 216 where data is output, the specific channel(s) 214 by which the data is output, etc.).

As shown, the data collected by the plugins 204 is communicated by the respective agent(s) 202 via a data plane that is comprised of the channel(s) 214 and destination(s) 216. In various embodiments, such destinations 216 may include any node of a user, administrator, and/or human/machine consumer of the data. Further, the destinations 216 may be separate/different from a logical, application-level control plane associated with the agents 202 and the plugins 204. Still yet, the channel(s) 214 may include any medium that is equipped to accommodate the communication of the type of data that is collected and communicated by the different plugins 204 via the respective agents 202. For example, in one possible embodiment, the channel(s) 214 may possibly include log aggregation channels adapted for collecting events logs from different systems and data sources, such as KAFKA, REDIS, HDFS, etc.

Further, the aforementioned control plane is provided with a manager in the form of a plurality of unified monitoring clusters 208 and a proxy 206. In use, such control plane enables control of the agents 202 (and the manner of data collection/communication utilizing the plugins 204) by communicating control signals 210 to the agents 202. As an option, the control plane may also enable status reporting from the agents 202 to the clusters 208 via the proxy 206. In one embodiment, the proxy 206 may accomplish such communications using sockets (e.g. internal endpoints, etc.). This may, in turn, enable more informed and/or intelligent control of the agents 202.

By this design, the control plane may enable more effective control of the data collection, processing, and/or data output via the different plugins 204 by administering such control via the respective agent(s) 202 that are equipped with such plugins 204. In one possible embodiment, the system 100 may thereby avoid use of multiple different agents (not shown) that perform the functionality of the plugins 204, where such different agents each require separate control/managers. Further, the proxy 206 may enable a more local and/or persistent connection with the respective agent(s) 202, so that the clusters 208 may be more remotely deployed over slower networks, without necessarily requiring a slower, less reliable connection directly between the agent(s) 202 and the clusters 208.

To this end, an entity (e.g. corporation, individual, etc.) may deploy the agents 202, plugins 204, and the proxy 206 in connection with one or more customer sites (including the respective nodes 205), as shown. Such deployment may further enable such customer(s) to monitor and/or control the manner in which the system 200 collects the data from the nodes 205 and communicates the same to customer-specified destinations 216 via customer-specified channel(s) 214. Thus, the customer may more effectively and/or efficiently monitor the nodes 205 at its sites.

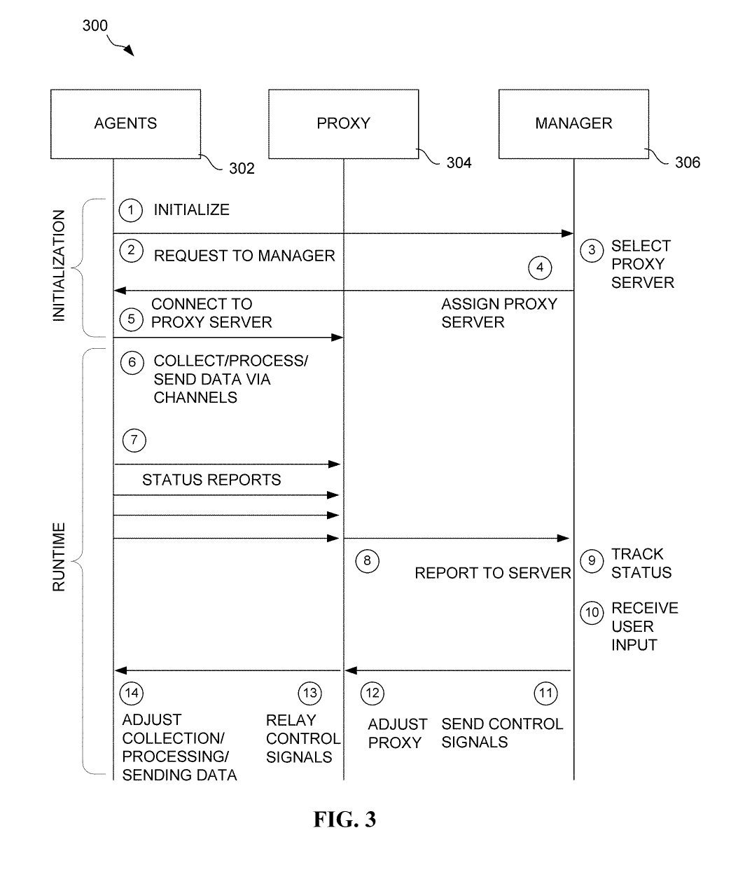

FIG. 3 illustrates a method 300 for data collection, in accordance with another embodiment. As an option, the method 300 may be implemented in the context of any one or more of the embodiments set forth in any previous and/or subsequent figure(s) and/or the description thereof. For example, in one possible embodiment, any of the features of the method 300 may be carried out in the context of the system 100 of FIG. 1 and/or the system 200 of FIG. 2. However, it is to be appreciated that the method 300 may be implemented in other suitable environments.

As shown, the method 300 involves an interaction between one or more agents 302, a proxy 304 (e.g. the proxies 106 of FIG. 1, the proxy 206 of FIG. 2), and a manager 306. After an initialization operation 1 of one of the agents 302 (e.g. at start-up or installation of a new agent), the agent(s) 302 sends an initialization signal (e.g. request, etc.) to the manager 306, as indicated operation 2. The purpose of such request is to indicate to the manager 306 that the agent(s) 302 is ready to start data collection and be assigned a proxy 304 for supporting such data collection.

In response, the manager 306 selects the proxy 304 for serving the agent(s) 302. See operation 3. In one embodiment, the manager 306 may select the proxy 304 based on an availability and/or a location of the proxy 304. For example, if the proxy 304 is within a predetermined threshold distance from the agent(s) 302, the proxy 304 is the closest proxy to the agent(s) 302, and/or the proxy 304 has sufficient network and/or processing bandwidth to service the agent(s) 302 (in addition to any it is already serving), the manager 306 may select the proxy 304 for serving the agent(s) 302. With such ability, the manager 306 may conduct load balancing in connection with proxies based on, for example, a number of the agents 302 in communication with the proxy 304.

To this end, the agents 302 are each configured for sending the initialization signal (possibly directly) to the manager 306, and the manager 306 is configured for, in response to the initialization signal, instructing the agents 302 (in operation 4) to communicate with the appropriate the proxy 304. This may be accomplished, in operation 5, by the agent(s) 302 connecting with the proxy 304 and establishing a persistent line of communication (e.g. via authentication, verification, etc.) that, in one embodiment, may be maintained (at a minimum frequency) for an entire duration of data collection by the agent(s) 302.

With communication established between the agent(s) 302 and the proxy 304, data collection, processing, and output (via appropriate channels) may be initiated in operation 6. With respect to such data collection, the agents 302 are each configured, in operation 7, for sending status information to the proxy 304 for being relayed to and stored by the manager in operations 8-9.

By this design, the agents 302 may be controlled based on the status information. For example, in one embodiment, the manager 306 may be equipped with manually-created and/or updated rules that result from user input received in operation 10. Further, such user input and/or rules may cause one or more control signals to be issued in operation 11 for both adjusting proxy operation (e.g. re-assigning a proxy) per operation 12, as well as relaying one or more control signals in operation 13 to the agents 302, for adjusting any desired aspect (e.g. collection, processing, output, etc.) of data collection. See operation 14.

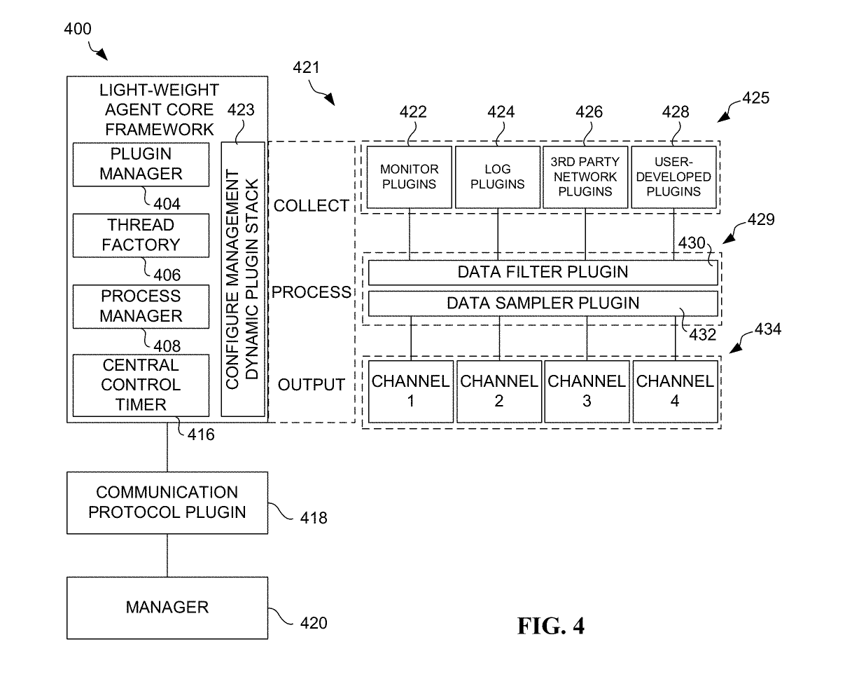

FIG. 4 illustrates an agent software framework 400 for collecting data, in accordance with an embodiment. As an option, the agent software framework 400 may be implemented in the context of any one or more of the embodiments set forth in any previous and/or subsequent figure(s) and/or the description thereof. For example, the agent software framework 400 may be implemented in the context of the agents 102 or 202 of FIGS. 1 and 2, respectively. However, it is to be appreciated that the agent software framework 400 may be implemented in other suitable environments.

As shown, the agent software framework 400 is extensible via a software plugin framework including a plurality of plugins 421 (e.g. see plugins 104 and 204 of FIGS. 1 and 2 respectively, etc.). The agent software framework 400 cooperates with such plugin framework which, in turn, may include different plugin types such as monitor plugins 422, log plugins 424, third party network plugins 426, and user developed plugins 428, just by way of example.

As an additional possibility, a plugin template may be provided for permitting customization of the operation thereof. In one possible embodiment, such plugin template may include an API template that may be employed by users to write their own plugins. Using such API template, a user may ensure that any incoming/outgoing communications (e.g. calls, etc.) of their plugins will have an appropriate format and follow an appropriate protocol, in order to ensure interoperability with the corresponding agent. By virtue of the new plugin code implementing such API, any new plugin will be compatible, manageable, and runnable by the corresponding agent.

To accomplish this, the agent software framework 400 includes a plugin manager 404, a thread factory 406, a process manager 408, and a timer 416. The plugin manager 404 is responsible for managing the loading of the plugins 421 and binding them into a processing stack 423 associated with one or more data channels, based on configuration data encoded in a configuration file that describes all parameters required for the construction of the agent software framework 400 at startup. As will be elaborated upon later, each complete monitoring task includes three operations, namely collection, processing (optional), and output; where each operation is carried out by a different plugin. By this design, all plugins may be folded into these three categories and organized into three corresponding stacks (i.e. layers). For a complete monitoring task configuration, at least one plugin is selected from a collection-related category/stack, at least one plugin is selected from an output-related category/stack, and at least one plugin is optionally selected from a process-related category/stack. Thus, such chosen plugins may be associated together (e.g. compiled, stitched together, etc.) by a configure file in order to form the processing stack 423, which collectively specifies what data is to be collected, how such data is to be processed, and where to output such data.

In one possible embodiment, such configuration file may be a JavaScript Object Notation (JSON) file with parameters that specify a number of threads in the agent software framework 400, a list of plugin descriptors (e.g. information about the plugin including a plugin identifier, plugin name, plugin version, and/or plugin description), a plugin type (e.g. shared library, external application), a list of plugin modules and a corresponding order of execution, etc. The thread factory 406 is a facility for creating configurable worker threads for plugin execution at agent start up time. Further, the timer 416 is a facility for providing timing service to the plugins 421 on time-sensitive tasks.

Moving to the process manager 408, such component controls overall plugin execution. In doing so, the process manager 408 dispatches worker threads from a pool of existent threads for executing the plugins 421 in regular time intervals that are controlled by the central control timer 416. In one embodiment, each plugin 421 may include a state machine that can be in either an active, paused, or error state (or any other state, for that matter). In the active state, the plugins 421 examine an input queue for work to perform. If there are messages in the queue, the plugins 421 dispatch the message, perform logic execution (i.e. data collection), and then pass the processed message to the input queue of the next stack layer of plugins 430 and/or 432 based on a data channel map, which defines the plugin stack 423. In the aforementioned pause or error state, the plugins 421 do nothing. Further, the plugin state is reported to a manager 420 (e.g. the manager 108 of FIG. 1) via a proxy (e.g. the proxy 106 of FIG. 1) using a communication protocol 418, in order to reflect both agent and plugin execution status. In some embodiments, the plugins 421 may be designed as a non-blocking state machine to improve performance of the agent software framework 400.

In various embodiments, the plugins 421 (or components thereof) may be of three types: an input (e.g. collect, ingress) type plugin 425, an output (e.g. egress) type plugin 434, and/or a processing-type plugin 429. The input-type plugin 425 may be configured for collecting data from a data source (e.g. log files, system metric, database, etc.). Further, the output-type plugin 434 may be configured for forwarding input data via various data channels to temporary in-transit memory (e.g. a cache), or a final storage destination. Such final destination may be a particular client (e.g. KAFKA client) for outputting data to relevant message brokers, a hypertext transfer protocol (HTTP) client for sending data to destination using a REST application program interface (API), a REDIS client for sending data to a REDIS key value cache, etc. By this design, the plugins 421 may be flexibly arranged, thus providing an extensible framework capable of accommodating various monitoring tasks.

With continuing reference to the plugins 421, the processing-type plugin 429 may be configured for data processing prior to forwarding via the output-type plugin 434. Such processing may take any form including, but not limited to filtering, encryption, sampling, etc. For instance, as shown in FIG. 4, such process-type plugins 429 may include a combination of a data filter plugin 430 and a data sampler plugin 432. As such, the agent software framework 400 permits the software plugins 421 to be stackable in order to form a complete data collection, processing, and forwarding stack in accordance to application requirements. Further, such plugins 421 may be configured during initialization, and further be re-configured during runtime.

As an option, data passing between the plugins 421 (or portions thereof) may occur via a messaging protocol composing of a fixed size message header and accompanied variable length data, if any. Through the message header, a message may be encoded as a control or data message. Further, each of the plugins 421 maintains a message queue for receiving ingress messages from one or more upper modules in the stack 423. In one possible embodiment, data direction may unidirectional from the upper to lower modules from the perspective of the stack 423. In other embodiments, bidirectional communication is contemplated.

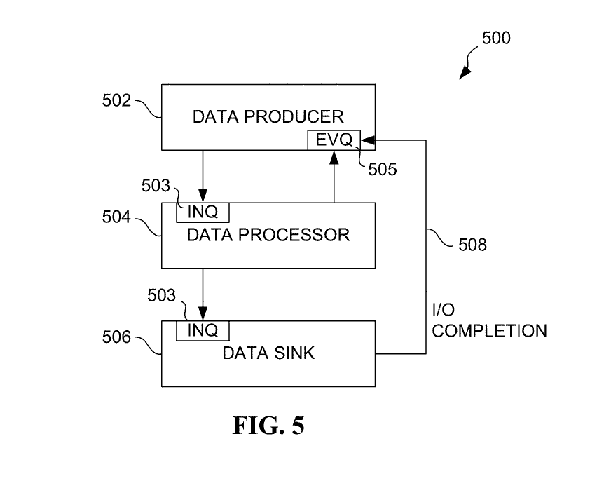

FIG. 5 illustrates a plugin stack 500 for collecting data, in accordance with another embodiment. As an option, the plugin stack 500 may be implemented in the context of any one or more of the embodiments set forth in any previous and/or subsequent figure(s) and/or the description thereof. For example, the plugin stack 500 may be implemented in the context of the plugin stack 423 of FIG. 4. However, it is to be appreciated that the plugin stack 500 may be implemented in other suitable environments.

As shown, the plugin stack 500 includes an input-type plugin in the form of a data producer 502 in communication with a process-type plugin in the form of a data processor 504 which, in turn, is in communication with an output-type plugin in the form of a data sink 506. Such plugins of the plugin stack 500 are equipped with input queues 503 for receiving messages form an upstream plugin, as well as an event queue (EVQ) 505 for receiving input/output (I/O) completion messages 508 that indicate when downstream processing of messages has been completed. In various embodiments, the I/O completion messages 508 may provide various indications including, but not limited to a finished indication, an error indication, a resend indication, and/or a no data indication, etc.

During execution, the plugin stack 500 is executed by an available thread in a thread pool via a thread factory (e.g. the thread factory 406 of FIG. 4). Once running, the plugin stack 500 dispatches messages from an input message queue for execution. Typically, such message queue is processed until no message is left in the queue. However, a developer may choose to impose a maximum number of messages to process prior to yielding the control of an underlying processor to other plugins. Nevertheless, each message may be processed until completion, at which point, the message is passed to the ingress message queue 503 of a next plugin module for either further processing or forwarding to a destined message broker.

In use, messages in a queue may be processed in a first-in-first-out (FIFO) order to preserve an order of ingress data and event sequence. Further, messages may be dynamically allocated on-demand by either the data producer 502 or an underlying processor, and passed to other plugins lower in the plugin stack 500. It should be noted that, when a plugin completes the processing of a received message, such plugin may either deposit the message into the message queue of the next plugin in the plugin stack 500 for further processing or, if the message is to be discarded, post the I/O completion message 508 to the originating plugin for the release of a message buffer to the system, as shown in FIG. 5. It should also be noted that the data producer 502 may pull data from any data source with which it is designed to cooperate.

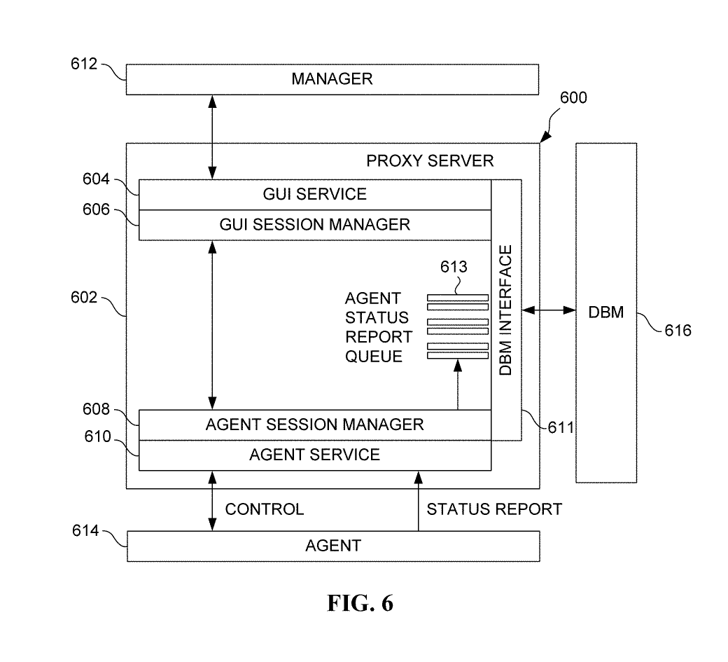

FIG. 6 illustrates a proxy server 600, in accordance with an embodiment. As an option, the proxy server 600 may be implemented in the context of any one or more of the embodiments set forth in any previous and/or subsequent figure(s) and/or the description thereof. For example, the proxy server 600 may be implemented in the context of the proxy 106 or proxy 206 of FIGS. 1 and 2, respectively. However, it is to be appreciated that the proxy server 600 may be implemented in other suitable environments.

As shown, the proxy server 600 is deployed between a manager 612 (e.g. the manager 108 of FIG. 1) and an agent 614 (e.g. the agents 102 of FIG. 1). The proxy server 600 serves to provide a management system endpoint near the agent 614 in order to optimize traffic between the agent 614 and the manager 612, and enable the direct control to the agents 614. By this design, scalability and responsiveness of the overall system is enhanced, in some embodiments.

The proxy server 600 further provides two services. A graphical user interface (GUI) service 604 (under the control of a GUI session manager 606) permits a user to issue commands at the manager 612 and ensures that those commands are relayed and implemented at the agent 614. Further, an agent service 610 (under the control of an agent session manager 606) permits the agent 614 to connect to the proxy server 600 to respond to commands and report agent status updates.

The proxy server 600 further employs a database management (DBM) interface 611 to employ a DMB service 616 in order to forward agent status reports to the manager 612. While the DMB service 616 is shown to be separate from the manager 612, it should be noted that, in various embodiments (that will be described later), such DMB service 616 may be a component of the manager 612.

As mentioned earlier, on startup, the agent 614 attempts to locate the proxy server 600 in its vicinity in order to connect to the same. This is accomplished by using a mapping service to locate a closest proxy in order to connect to the same. Such closest proxy may be a pre-configured proxy cluster designated to serve the agent 614. Besides providing proxy location service to the agent 614, such mapping service implements a load distribution algorithm in order to distribute agent connection load to available proxy servers such as the proxy server 600. Further detail on the operations of such mapping service will be elaborated upon during the description of subsequent embodiments.

Once connected to the proxy server 600, the agent 614 may report its operational status to the manager 612 and such status may be stored via the DMB service 616 which, in turn, may be immediately retrieved and viewed by an administrator through a web-based console or other interface. Through this, the administrator may monitor the execution status of any single individual agent including the agent 614 and its plugin modules in real-time or near real-time, and issue commands to the agent 614 for controlling its operations.

To avoid network traffic latency to the DMB service 616, the proxy server 600 may cache the report in a queue 613 until either the queue 613 reaches a configurable watermark or when a configurable queuing time limit expires. Once the DMB service 616 receives the report(s), it may immediately records the report(s) to an agent status database, which is then consumed by the manager 612 for display on the GUI console (which can also be used to control the agent 614).

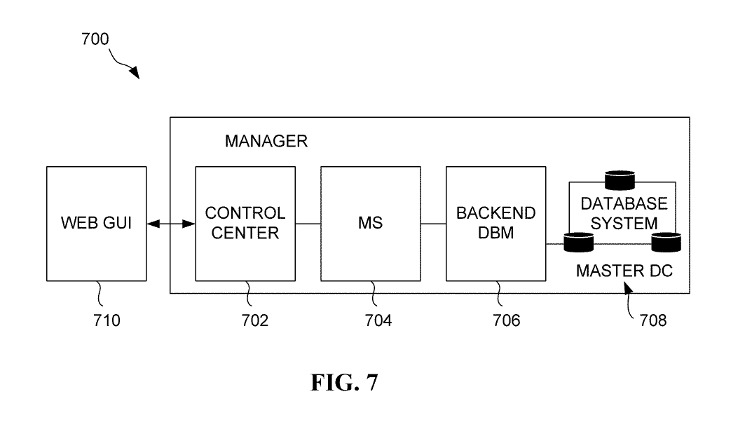

FIG. 7 illustrates a manager 700, in accordance with an embodiment. As an option, the manager 700 may be implemented in the context of any one or more of the embodiments set forth in any previous and/or subsequent figure(s) and/or the description thereof. For example, the manager 700 may be implemented in the context of the manager 108 of FIG. 1. However, it is to be appreciated that the manager 700 may be implemented in other suitable environments.

As shown, the manager 700 includes a mapping server (MS) 704, a control center system 702, a DBM system 706, a database system 708, and a web-based GUI 710. In one possible embodiment, each of the foregoing components of the manager 700 may be implemented as a cluster of several duplicate servers, for scalability and high availability. In use, the MS 704 holds a service-location map of the entire system (of agents/proxies), and provides a service-to-location facility to the components of the system.

The DBM system 706 handles database requests from management components of the system including, but not limited to the MS 704, the control center system 702, any proxy, etc. In one possible embodiment, only the DBM system 706 has direct access to the database system 708. As an additional option, the database system 708 may implement MySQL.

In one embodiment, the control center system 702 may include a server for providing data presentation services to web browser users. Further, the control center system 702 may implement a management system that users can employ for point-and-click management of all components of the entire system. The control center system 702 may also use services provided by the DBM system 706 and proxies. It may also use the MS 704 to locate, at start up, an appropriate database service and proxy service for specific operations.

As mentioned earlier, the manager 700 and any of its components can be deployed as a cluster configuration for scalability and high-availability. In other embodiments, the manager 700 may be deployed in the same or different data centers (DCs) as that of the proxy server clusters. For example, in one embodiment, the manager 700 may be deployed in a remote data center while communicating with proxy server clusters deployed in other data centers. In such configuration, a user using a web browser may graphically view a status of the entire system and manage every system component in real-time or near real-time. By this design, the system, in some embodiments, may permit fine-grained, direct point-and-click control and management of every component of the system and real-time or near real-time responsiveness of the managed components from a remote location regardless of the number of agents.

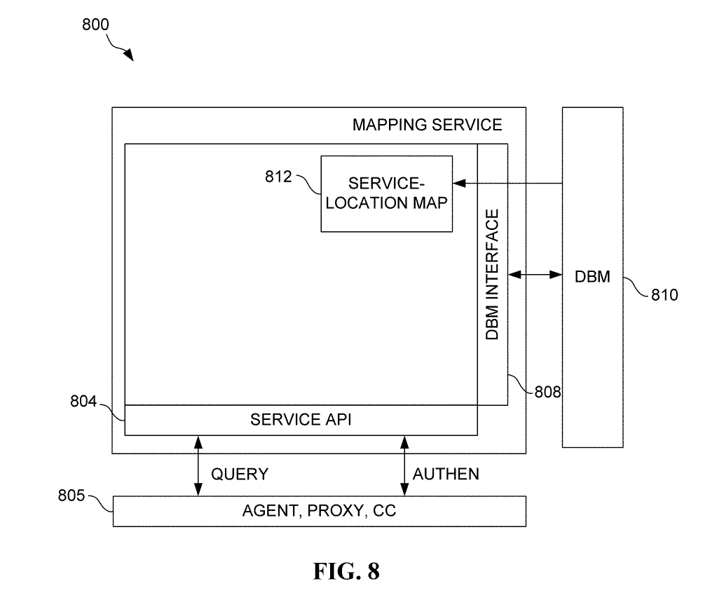

FIG. 8 illustrates a mapping server 800, in accordance with an embodiment. As an option, the mapping server 800 may be implemented in the context of any one or more of the embodiments set forth in any previous and/or subsequent figure(s) and/or the description thereof. For example, the mapping server 800 may be implemented in the context of the MS 704 of FIG. 7. However, it is to be appreciated that the mapping server 800 may be implemented in other suitable environments.

The mapping server 800 provides a mapping service to other system components 805 (e.g. agents, proxies, other manager components, etc.). To accomplish this, the mapping server 800 includes a service API 804 for interfacing such other system components 805, as well as a DBM interface 808 for interfacing a DBM 810 (e.g. the DBM 706 of FIG. 7). Further, the mapping server 800 maintains a server status table in the form of a service-location map 812 in a system database (e.g. the database system 708 of FIG. 7) via the DBM interface 808 and the DBM 810. Such service-location map 812 is periodically updated through status reports (e.g. heart-beat, etc.) implemented by every system component, including all proxy servers and agents.

Still yet, the mapping server 800 retrieves server status data from the DBM 810 and uses such data to provide a location service to the system components 805 that are registered with the DBM 810. By this design, prior to using the mapping service, a system component(s) 805 may authenticate with the mapping server 800 which, in turn, collaborates with the DBM 810, in order to validate the system component(s) 805. To support this feature, each of the system components 805 may be pre-configured with an Internet Protocol (IP) address of the mapping server 800, in order to locate the mapping service on startup.

Once the system component(s) 805 are successfully authenticated, the system component(s) 805 may query the mapping service for a type of desired service. For GUI and proxy servers that require the DBM service, such components may query for an active DBM server from the mapping server 800. For agents, such service(s) may be achieved via an associated proxy and, therefore, the mapping server 800 may determine an appropriate corresponding proxy server for the requesting agent. Such corresponding proxy server may be a proxy server serving agents in a specific geographical location, (e.g. data center). Further, the proxy server may be located in a proximity of the agents it serves, but could also be anywhere else determined by the administrator through an agent-proxy association map maintained in the database system.

The DBM interface 808 serves as an interface to the DBM 810 which may be any scalable SQL or NoSQL database system such as MySQL, ORACLE DBMS, MongoDB, Elasticsearch, or a combination thereof. Further, the DBM 810 maintains a number of databases including: a registration database that records IP address of all proxy server and agents, a server status database that records a status of all registered management servers, an agent status database that records a status of all registered agents, and a plugin description database that records a description of available plugin modules and any configurable parameters associated therewith.

In use, a proxy server or agent can only join a manager if there is a corresponding registration record (for such component) with the system. For security reasons, both proxy servers and agents are to successfully authenticate with the manager before access to services is provided. The DBM 810 provides a set of REST and SOCKET.IO API services. The REST API service is used by the control center to access various databases of the system to provide support for administration GUI operations from remote web browser instances, which includes component status retrieval for display, configuration updates, management control and, configuration and plugin module deployment.

In one embodiment, a SOCKET.IO service may implement an API to provide support for serve status reports through a periodic heart-beat mechanism. Such heart-beat message may contain a unique server identifier and other status information such as server health, connection load, etc. Additionally, the SOCKET.IO service may also provide an API for the proxy servers to submit agent status reports received from the connected agents on demand.

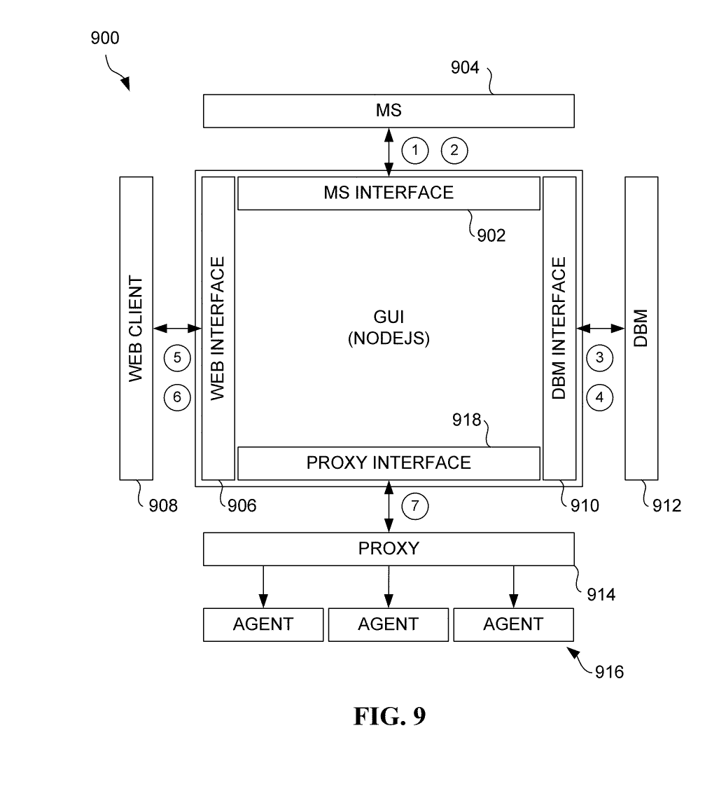

FIG. 9 illustrates a GUI-equipped central control system 900, in accordance with an embodiment. As an option, the central control system 900 may be implemented in the context of any one or more of the embodiments set forth in any previous and/or subsequent figure(s) and/or the description thereof. For example, the central control system 900 may be implemented in the context of the central control system 702/GUI 710 of FIG. 7. However, it is to be appreciated that the central control system 900 may be implemented in other suitable environments.

The GUI-equipped central control system 900 includes a MS interface 902 for interfacing with at least one MS 904, a web interface 906 for interfacing a web client 908, a DBM interface 910 for interfacing with a DBM 912, and a proxy interface 918 for interfacing with one or more proxies 914 which, in turn, facilitate communication with a plurality of agents 916. By this design, the GUI-equipped central control system 900 provides a frontend graphical user interface webserver that allows a user to view all system components (e.g. manager, proxies, agents, etc.), and a backend service to transfer data and deploy tasks. In some embodiments, the GUI-equipped central control system 900 may also implement a dispatcher (e.g. NodeJS workers, etc.) to distribute deployment load evenly and in parallel. Further, the GUI-equipped central control system 900 may also connect to the DBM 912 via the DBM interface 910 for presenting various information to the user, as well as permitting the user to control various aspects of the overall system.

In one exemplary use case, a request to the system is made via the MS interface 902 for authentication in operation 1. In operation 2, a DBM IP is requested and received from MS 904. In operation 3, a web socket connection is established to the DBM 912. Further, a server status report is sent to the DBM 912, as indicated in operation 4. In operation 5, the web client 908 connects via a REST API. To this end, a user may, in operation 6, view, edit, create, and delete records in the database via DBM interface 910. Further, in operation 7, commands may be sent to implement collection, processing, and/or output tasks to agents via the proxy interface 918.

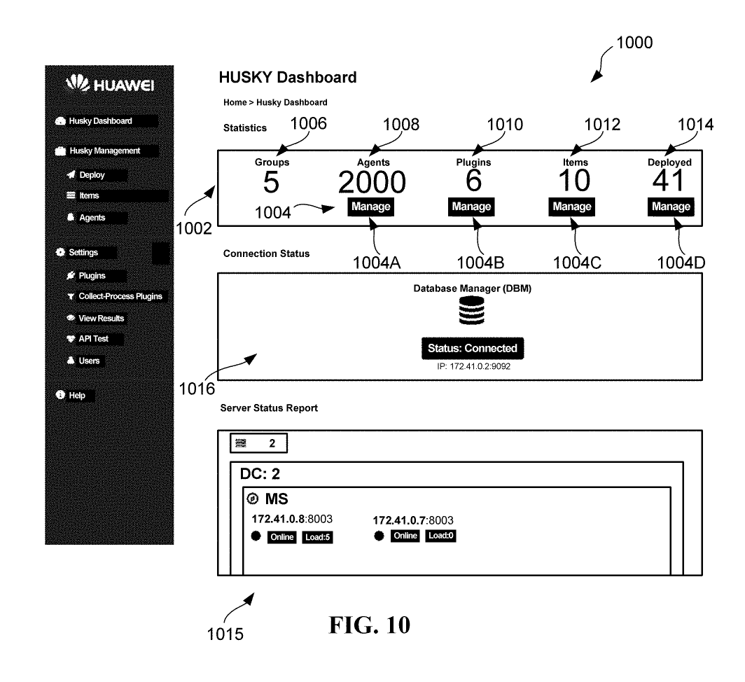

FIG. 10 illustrates a sample GUI 1000 for administering a system, in accordance with an embodiment. As an option, the GUI 1000 may be implemented in the context of any one or more of the embodiments set forth in any previous and/or subsequent figure(s) and/or the description thereof. For example, the GUI 1000 may be implemented in the context of the central control system 900 of FIG. 9. However, it is to be appreciated that the GUI 1000 may be implemented in other suitable environments.

As mentioned earlier, a GUI-equipped central control system (e.g. the GUI-equipped central control system 900 of FIG. 9) may connect to a DBM for presenting various statistics 1002 to the user as well as permitting the user to control various aspects of the overall system via associated management icons 1004. Specifically, as shown in FIG. 10, the GUI 1000 presents a number of groups 1006 that each represents a grouping of agents. Further, the GUI 1000 presents a number of such agents 1008 which a user is allowed to control via an associated agent management icon 1004A, so as to allow the user to apply commands to suspend and/or resume agent plugin operations.

The GUI 1000 further presents a number of plugins 1010 and an associated plugin management icon 1004B that may be used to gain access to menus, etc. for uploading, removing, upgrading, etc. such plugins. Still yet, the GUI-equipped central control system 900 may display a number of items 1012 and an associated item management icon 1004C that may be used to manage items (in the form of rules, etc.) to be applied to agent plugins. Also presented by the GUI 1000 is a number of deployments 1014 and an associated deployment management icon 1004 for building plugin configurations and deploying plugin configurations to a proxy that, in turn, distributes the plugin configurations and plugin files to applicable agents.

In various embodiments, the GUI 1000 may be pre-configured with a list of MS hosts for connecting to at startup and such list may be displayed in the form of a server status report 1015. When a connecting MS host fails, the GUI 1000 may indefinitely cycle through MS host IPs in order to reconnect. Upon MS connection, the GUI 1000 may be authenticated and request a valid DBM IP through the MS. Further, a user can connect to a webserver associated with the GUI 1000 via a browser through REST APIs. A GUI backend service may then send/receive data through a websocket to DBM, and a status 1016 may be displayed by the GUI 1000. Upon receipt of user-initiated commands, the GUI 1000 may connect to a proxy via a web socket and instruct the proxy to send commands, plugin configuration and files, etc. to selected agents.

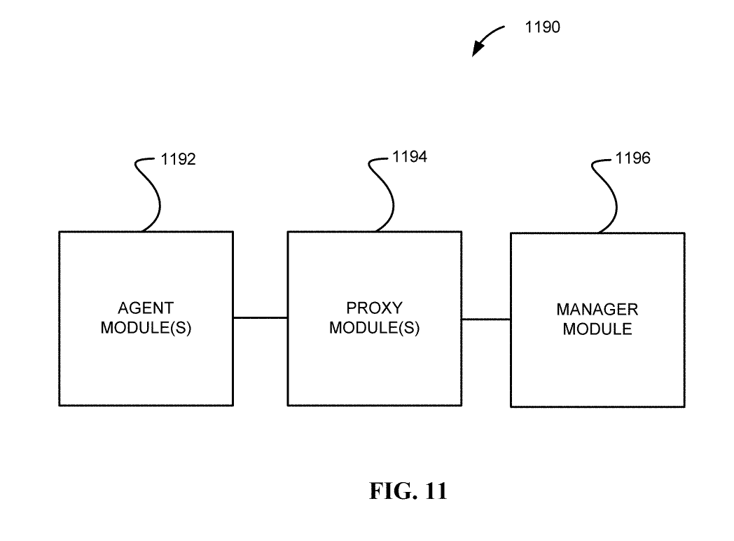

FIG. 11 illustrates a data collection system 1190, in accordance with an embodiment. As an option, the data collection system 1190 may be implemented with one or more features of any one or more of the embodiments set forth in any previous and/or subsequent figure(s) and/or the description thereof. However, it is to be appreciated that the data collection system 1190 may be implemented in other suitable environments.

As shown, an agent means in the form of an agent module 1192 is provided for collecting data from at least one node, utilizing a plurality of plugins, and communicating the data to a destination via at least one channel. In various embodiments, the agent module 1192 may include, but is not limited to the agents 102 of FIG. 1, at least one processor (to be described later) and any software controlling the same, and/or any other circuitry capable of the aforementioned functionality.

Also included is a manager means in the form of a manager module 1196 for receiving user input for controlling one or more aspects of the collection of the data from the at least one node and the communication of the data to the destination, and generating control signals based on the user input. In various embodiments, the manager module 1196 may include, but is not limited to the manager 108 of FIG. 1, at least one processor (to be described later) and any software controlling the same, and/or any other circuitry capable of the aforementioned functionality.

With continuing reference to FIG. 11, proxy means in the form of a proxy module 1194 is in communication with the agent module 1192 and the manager module 1196 for receiving the control signals, and controlling the one or more aspects of the collection of the data from the at least one node and the communication of the data to the destination, based on the control signals. In various embodiments, the proxy module 1194 may include, but is not limited to the proxies 106 of FIG. 1, at least one processor (to be described later) and any software controlling the same, and/or any other circuitry capable of the aforementioned functionality.

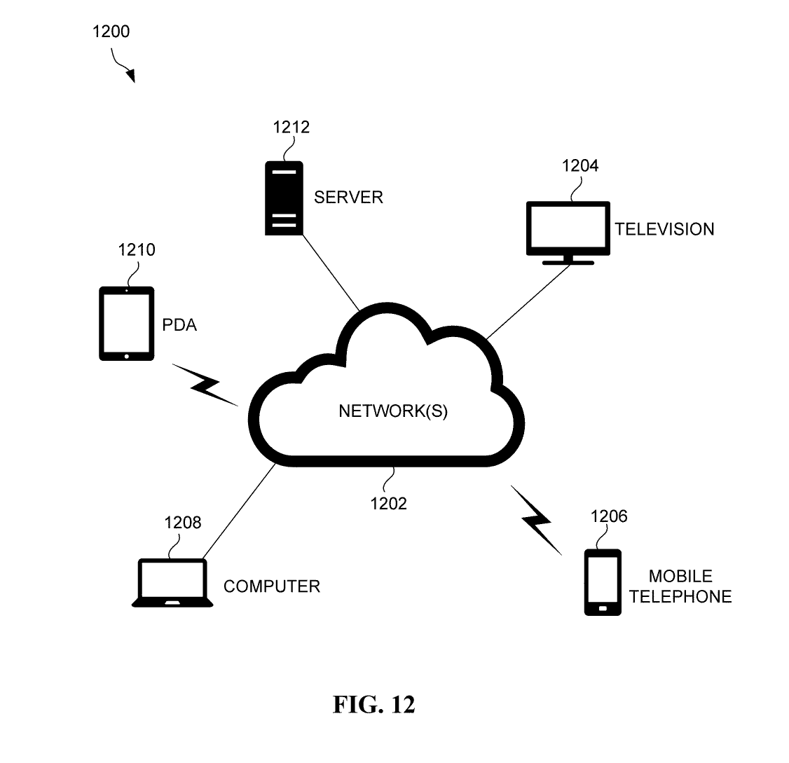

FIG. 12 is a diagram of a network architecture 1200, in accordance with an embodiment. As shown, at least one network 1202 is provided. In various embodiments, any one or more components/features set forth during the description of any previous figure(s) may be implemented in connection with any one or more of the components of the at least one network 1202.

In the context of the present network architecture 1200, the network 1202 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1202 may be provided.

Coupled to the network 1202 is a plurality of devices. For example, a server 1212 and a computer 1208 may be coupled to the network 1202 for communication purposes. Such computer 1208 may include a desktop computer, lap-top computer, and/or any other type of logic. Still yet, various other devices may be coupled to the network 1202 including a personal digital assistant (PDA) device 1210, a mobile phone device 1206, a television 1204, etc.

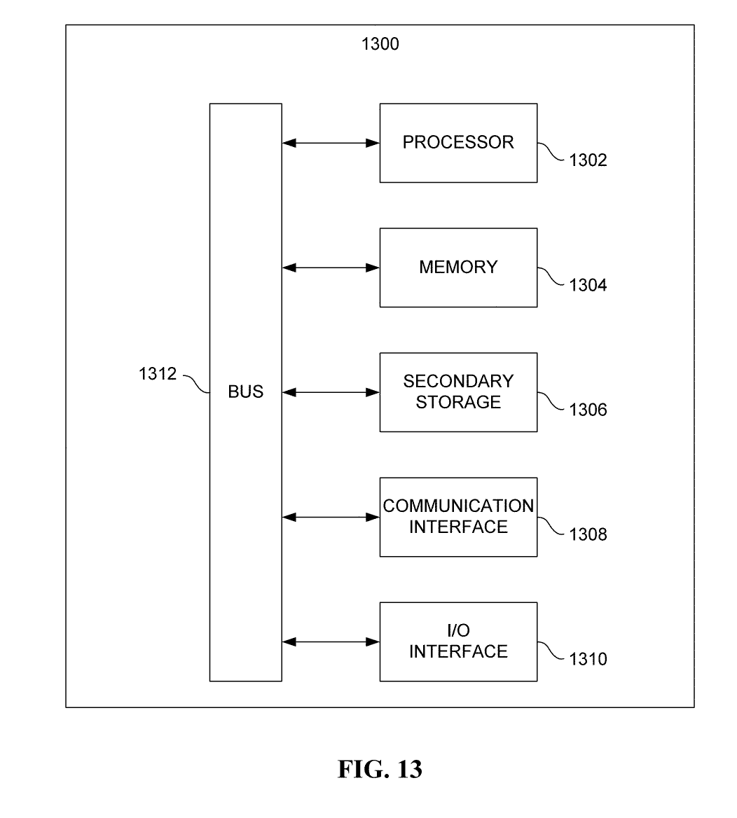

FIG. 13 is a diagram of an exemplary processing device 1300, in accordance with an embodiment. As an option, the processing device 1300 may be implemented in the context of any of the devices of the network architecture 1200 of FIG. 12. However, it is to be appreciated that the processing device 1300 may be implemented in any desired environment.

As shown, the processing device 1300 includes at least one processor 1302 which is connected to a bus 1312. The processing device 1300 also includes memory 1304 [e.g., hard disk drive, solid state drive, random access memory (RAM), etc.] coupled to the bus 1312. The memory 1304 may include one or more memory components, and may even include different types of memory. Further included is a communication interface 1308 (e.g. local/remote network interface, memory access interface, etc.) and an input/output (I/O) interface 1310 (e.g. display, speaker, microphone, touchscreen, touchpad, mouse interface, etc.).

The processing device 1300 may also include a secondary storage 1306. The secondary storage 1306 coupled to the bus 1312 and/or to other components of the processing device 1300. The secondary storage 1306 can include, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 1304, the secondary storage 1306, and/or any other memory, for that matter. Such computer programs, when executed, enable the processing device 1300 to perform various functions (as set forth above, for example). Memory 1304, secondary storage 1306 and/or any other storage comprise non-transitory computer-readable media.

In one embodiment, the at least one processor 1302 executes instructions in the memory 1304 or in the secondary storage 1306 to implement any of the functionality set forth earlier in connection with the agents, proxies, and/or manager.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

Computer-readable non-transitory media includes all types of computer readable media, including magnetic storage media, optical storage media, and solid state storage media and specifically excludes signals. It should be understood that the software can be installed in and sold with the devices described herein. Alternatively the software can be obtained and loaded into the devices, including obtaining the software via a disc medium or from any manner of network or distribution system, including, for example, from a server owned by the software creator or from a server not owned but used by the software creator. The software can be stored on a server for distribution over the Internet, for example.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the embodiments as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A proxy processing device, comprising:
a non-transitory memory storing instructions; and
one or more processors in communication with the non-transitory memory, wherein the one or more processors execute the instructions to:
receive control signals from a manager that are based on user input received by the manager; and
send the control signals to an agent for controlling one or more aspects of a collection of data from at least one node and a communication of the data to a destination via at least one channel, the collection of the data and the communication of the data being performed by the agent utilizing a plurality of software components that each customize the one or more aspects of the collection of the data and the communication of the data.

2. The proxy processing device of claim 1, wherein the one or more aspects include a selection of the destination of the data among a plurality of destinations.

3. The proxy processing device of claim 1, wherein the one or more aspects include a selection of the at least one channel among a plurality of channels.

4. The proxy processing device of claim 1, wherein the control signals are further for controlling one or more aspects of a processing of the data collected from the at least one node before the communication of the data to the destination.

5. The proxy processing device of claim 4, wherein the processing includes at least one of sampling, encryption, or filtering of the data.

6. The proxy processing device of claim 1, wherein a communication of the proxy processing device with the agent is more frequent than a communication of the proxy processing device with the manager.

7. The proxy processing device of claim 1, wherein the agent sends an initialization signal to the manager, and the manager, in response to the initialization signal, instructs the agent to communicate with the proxy processing device.

8. The proxy processing device of claim 7, wherein the manager instructs the agent to communicate with the proxy processing device, based on at least one of an availability or a location of the proxy processing device.

9. The proxy processing device of claim 1, wherein the one or more processors execute the instructions to:
receive status information from the agent; and
send the status information to the manager, where the control signals are based, at least in part, on the status information.

10. The proxy processing device of claim 1, wherein the manager conducts load balancing in connection with the proxy processing device based on a number of the agents in communication with the proxy processing device.

11. The proxy processing device of claim 1, wherein the software components are capable of including different types of software components that collect the data differently.

12. The proxy processing device of claim 1, wherein the software components include plugins.

13. The proxy processing device of claim 12, wherein the plugins include a first plugin for the collection of the data and a second plugin for the communication of the data to the destination via the at least one channel.

14. The proxy processing device of claim 13, wherein the plugins include a third plugin for processing of the data collected from the at least one node before the communication of the data to the destination.

15. A computer-implemented method, comprising:
receiving control signals from a manager that are based on user input received by the manager; and
sending the control signals to an agent for controlling one or more aspects of a collection of data from at least one node and a communication of the data to a destination via at least one channel, the collection of the data and the communication of the data being performed by the agent utilizing a plurality of software components that each customize the one or more aspects of the collection of the data and the communication of the data.

16. The method of claim 15, wherein the one or more aspects include a selection of the destination of the data among a plurality of destinations.

17. The method of claim 15, wherein the one or more aspects include a selection of the at least one channel among a plurality of channels.

18. The method of claim 15, wherein the control signals are further for controlling one or more aspects of a processing of the data collected from the at least one node before the communication of the data to the destination.

19. The method of claim 18, wherein the processing includes at least one of sampling, encryption, or filtering of the data.

20. The method of claim 15, wherein a communication with the agent is more frequent than a communication with the manager.

21. The method of claim 15, wherein the agent sends an initialization signal directly to the manager, and the manager, in response to the initialization signal, instructs the agent to communicate with a proxy processing device.

22. The method of claim 21, wherein the manager instructs the agent to communicate with the proxy processing device, based on at least one of an availability or a location of the proxy processing device.

23. The method of claim 15, and further comprising:
receiving status information from the agent; and
sending the status information to the manager, where the control signals are based, at least in part, on the status information.

24. The method of claim 15, wherein the manager conducts load balancing based on a number of the agents in communication with a proxy processing device.

25. The method of claim 15, wherein the software components are capable of including different types of software components that collect the data differently.

26. The method of claim 15, wherein the software components include plugins.

27. The method of claim 26, wherein the plugins include a first plugin for the collection of the data and a second plugin for the communication of the data to the destination via the at least one channel.

28. The method of claim 27, wherein the plugins include a third plugin for the processing of the data collected from the at least one node before the communication of the data to the destination.

29. A computer program product comprising computer executable instructions stored on a non-transitory computer readable medium that when executed by a processor instruct the processor to:
receive control signals from a manager that are based on user input received by the manager; and
send the control signals to an agent for controlling one or more aspects of a collection of data from at least one node and a communication of the data to a destination via at least one channel, the collection of the data and the communication of the data being performed by the agent utilizing a plurality of software components that each customize the one or more aspects of the collection of the data and the communication of the data.
